(19) United States
(12) Patent Application Publication
(10) Pub. No.: US 2007/0238006 A1
(43) Pub. Date: Oct. 11, 2007

(54) Water management properties of pem fuel cell bipolar plates using carbon nano tube coatings

(76) Inventors: Gayatri Vyas, Rochester Hills, MI (US); Mahmoud H. Abd Elhamid, Grosse Pointe Woods, MI (US); Youssef M. Mikhail, Sterling Heights, MI (US)

Correspondence Address: CARY W. BROOKS;General Motors Corporation - Legal Staff, Mail Code 482-C23-B21, P.O. Box 300, Detroit, MI, 48265-3000, US

(21) Appl. No.: 11/215,105

(22) Filed: Aug. 30, 2005

(51) Int. Cl. H01M 8/02; B05D 5/12

(52) U.S. Cl. 429/38; 427/115; 427/122

(57) ABSTRACT

A flow field plate or bipolar plate for a fuel cell that includes a carbon nano tube or carbon nano fiber coating that makes the bipolar plate conductive hydrophilic. Further, the carbon nano tube or carbon nano fiber coating is stable in the fuel cell environment and does not corrode.

### BACKGROUND OF THE INVENTION

1. Field of the Invention

This invention relates generally to bipolar plates for fuel cells and, more particularly, to a bipolar plate for a fuel cell that includes a carbon nano tube or carbon nano fiber coating that makes the plate more hydrophilic to increase the water transport capability of the flow field channels in the plate.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs require certain conditions for effective operation, including proper water management and humidification, and control of catalyst poisoning constituents, such as carbon monoxide (CO).

Several fuel cells are typically combined in a fuel cell stack to generate the desired power. For the automotive fuel cell stack mentioned above, the stack may include about two hundred fuel cells. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of the MEA. Cathode gas flow channels are provided on the cathode side of the bipolar plates that allow the cathode gas to flow to the cathode side of the MEA. The bipolar plates also include flow channels through which a cooling fluid flows.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is not conductive, and thus increases the internal resistance of the fuel cell, reducing its electrical performance. Also, the oxide layer makes the plate more hydrophobic.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², the water accumulates within the flow channels because the flow rate of the reactant gas is too low to force the water out of the channels. As the water accumulates, it forms droplets that continue to expand because of the relatively hydrophobic nature of the plate material. The contact angle of the water droplets is generally about 90° in that the droplets form in the flow channels substantially perpendicular to the flow of the reactant gas. As the size of the droplets increases, the flow channel is closed off, and the reactant gas is diverted to other flow channels because the channels are in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the cathode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

### SUMMARY OF THE INVENTION

In accordance with the teachings of the present invention, a flow field plate or bipolar plate for a fuel cell is disclosed that includes a carbon nano tube or carbon nano fiber coating that makes the plate hydrophilic.

Additional, features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack that includes bipolar plates having a carbon nano tube or carbon nano fiber coating that makes the plates hydrophilic, according to an embodiment of the present invention; and

FIG. 2 is an SEM micrograph showing a carbon nano tube coating deposited on a substrate.

### DETAILED DESCRIPTION OF THE EMBODIMENTS

The following discussion of the embodiments of the invention directed to a bipolar plate for a fuel cell that includes a carbon nano tube or carbon nano fiber coating to make the bipolar plate hydrophilic is merely exemplary in nature, and is in no way intended to limit the invention or its applications or uses.

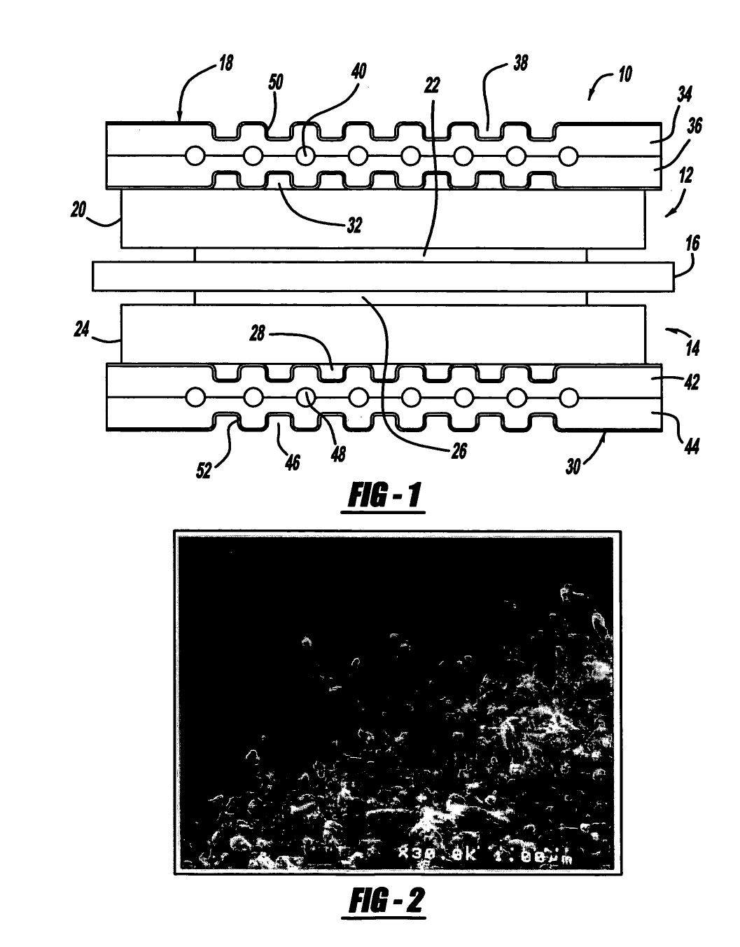

FIG. 1 is a cross-sectional view of a fuel cell 10 that is part of a fuel stack of the type discussed above. The fuel cell 10 includes a cathode side 12 and an anode side 14 separated by a perfluorosulfonic acid membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. A hydrogen reactant gas flow from flow channels 28 in the bipolar plate 30 reacts with the catalyst layer 26 to dissociate the hydrogen ions and the electrons. Airflow from flow channels 32 in the bipolar plate 18 reacts with the catalyst layer 22. The hydrogen ions are able to propagate through the membrane 16 where they electro-chemically react with the airflow and the return electrons in the catalyst layer 22 to generate water as a by-product.

In this non-limiting embodiment, the bipolar plate 18 includes two sheets 34 and 36 that are stamped and welded together. The sheet 36 defines the flow channels 32 and the sheet 34 defines flow channels 38 for the anode side of an adjacent fuel cell to the fuel cell 10. Cooling fluid flow channels 40 are provided between the sheets 34 and 36, as shown. Likewise, the bipolar plate 30 includes a sheet 42 defining the flow channels 28, a sheet 44 defining flow channels 46 for the cathode side of an adjacent fuel cell, and cooling fluid flow channels 48. In the embodiments discussed herein, the sheets 34, 36, 42 and 44 are made of a suitable electrically conductive material, such as stainless steel, titanium, aluminum, polymeric carbon composites, etc.

According to one embodiment of the present invention, a carbon nano tube or carbon nano fiber coating 50 is deposited on the bipolar plate 18 and a carbon nano tube or carbon nano fiber coating 52 is deposited on the bipolar plate 30. As is well understood in the art, carbon nano tube is a graphitized carbon material that forms strings or fibers of carbon. The carbon nano tube coatings 50 and 52 make the bipolar plates 18 and 30 hydrophilic in that the configuration of the nano tubes in the coatings 50 and 52 cause water to be wicked into the coatings 50 and 52 and be drawn away. Further, the carbon in the carbon nano tube coatings 50 and 52 are corrosion resistant and conductive, all desirable properties for the bipolar plates 18 and 30. An SEM micrograph of a carbon nano-tube coating deposited on a substrate is shown in FIG. 2.

In one embodiment, the contact angle of the coatings 50 and 52 is less than 5°. Also, it has been shown that organic contaminants and other matter that typically adhere to the surface of bipolar plates do not significantly affect the hydrophilicity of the carbon nano tube coatings 50 and 52 because of the large surface area of the coatings 50 and 52 provided by the nano tubes and the porosity of the coatings 50 and 52. Further, the carbon nano tube coatings 50 and 52 are able to withstand high temperatures, and it is cost effective to produce and deposit the coatings 50 and 52 on the bipolar plates 18 and 30.

The carbon nano tube coatings 50 and 52 are chemically stable in a hydrofluoric acid (HF) environment. As is well understood in the art, hydrofluoric acid is generated in the fuel cell 10 as a result of degradation of the perfluorosulfonic ionomer in the membrane 16 during operation of the fuel cell. The hydrofluoric acid has a corrosive effect on various fuel cell materials, including other coatings known in the art for making the bipolar plates 18 and 30 hydrophilic. Therefore, eventually the hydrophilic coating of these known materials will be completely etched away. The hydrofluoric acid does not etch away the carbon material of the carbon nano tube coatings 50 and 52, and therefore, the coatings 50 and 52 are maintained in tact for the life of the fuel cell 10.

Before the coatings 50 and 52 are deposited on the bipolar plates 18 and 30, the bipolar plates 18 and 30 are cleaned by a suitable process, such as ion beam sputtering or etching, to remove the resistive oxide film on the outside of the plates 18 and 30 that may have formed. The carbon nano tube coatings 50 and 52 can be deposited on the bipolar plates 18 and 30 by any suitable process including, but not limited to, a chemical vapor deposition process (CVD) which uses acetylene as a carrier gas, physical vapor deposition processes, and thermal spraying processes. Further, the carbon nano tube coatings 50 and 52 can be brushed onto the bipolar plates 18 and 30. Also, the carbon nano tube coatings 50 and 52 are able to be deposited on the bipolar plates 18 and 30 at low temperature. Suitable examples of physical vapor deposition processes include electron beam evaporation, magnetron sputtering and pulsed plasma processes. Suitable chemical vapor deposition processes include plasma enhanced CVD and atomic layer deposition processes. One process produces the carbon nano tubes so that the nano tubes or nano fibers are about 15-20 nm in diameter. In one embodiment, the thickness of the carbon nano tubes coatings 50 and 52 is in the 100-1000 nm range.

In one embodiment for depositing carbon nano tube coatings, the base metal, for example stainless steel, of the plate is coated with a very thin, such as 2 nm, chromium (Cr) or nickel (Ni) layer, and then the surface is exposed to an acetylene carrier gas at 500° C. The acetylene gas decomposes forming hydrogen gas.

As mentioned above, the carbon nano tube coatings 50 and 52 are conductive. Therefore, by depositing the carbon nano tube coatings 50 and 52 on the bipolar plates 18 and 30, the bipolar plates 18 and 30 have a low ohmic resistance, and thus are conducive for conducting electricity out of the fuel cell. Further, the carbon nano tube coatings 50 and 52 are resistant to corrosion. Further, when the carbon nano tube material is graphitized, it becomes more conductive and corrosion resistant.

It is known in the art to use carbon black as the carrier for the catalyst in the catalyst layers 22 and 26. However, according to another embodiment of the invention, because of the large surface area provided by carbon nano tubes and carbon fibers, a carbon nano tube coating can also be used as a carrier for the catalyst material, such as platinum, for the catalyst layers 22 and 26. This would be an added benefit because carbon black currently being used as the carrier typically corrodes in the fuel cell environment, whereas the carbon nano tube material does not.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising a flow field plate being made of a plate material, said flow field plate including a plurality of flow channels that receive a reactant gas, said flow field plate further including a carbon nano tube or carbon nano fiber coating that makes the flow field plate hydrophilic.

2. The fuel cell according to claim 1 wherein the plate material is selected from the group consisting of steel, titanium, aluminum and a polymer-carbon composite based material.

3. The fuel cell according to claim 1 wherein the carbon nano tube or carbon nano fiber coating has a thickness in the 100-1000 nm range.

4. The fuel cell according to claim 1 wherein the carbon nano tube or carbon nano fiber coating is deposited on the flow field plate by a chemical vapor deposition process that uses acetylene as a carrier gas.

5. The fuel cell according to claim 1 wherein a thin Cr or Ni layer is deposited on the flow field plate before the carbon nano tube or carbon nano fiber coating.

6. The fuel cell according to claim 1 wherein the flow field plate is selected from the group consisting of anode-side flow field plates and cathode-side flow field plates.

7. The fuel cell according to claim 1 wherein the carbon nano tube or carbon nano fiber coating is a graphitized carbon nano tube or carbon nano fiber coating.

8. The fuel cell according to claim 1 further comprising a membrane electrode assembly including at least one catalyst layer, said catalyst layer including catalyst particles formed in a binder layer, said binder layer being a carbon nano tube or carbon nano fiber binder.

9. The fuel cell according to claim 1 wherein the fuel cell is part of the fuel cell stack on a vehicle.

10. A fuel cell stack including a stack of fuel cells, said fuel cell stack comprising a plurality of anode-side and cathode-side flow field plates, said flow field plates including a plurality of flow channels where the flow channels in the anode-side flow field plates receive hydrogen and the flow channels in the cathode-side flow field plates receive air, said flow field plates further including a carbon nano tube or carbon nano fiber coating that makes the flow field plates hydrophilic so as to prevent water from blocking the flow channels.

11. The fuel cell stack according to claim 10 wherein the flow field plates are made of a material selected from the group consisting of steel, titanium, aluminum and a polymer-carbon composite based material.

12. The fuel cell stack according to claim 10 wherein the carbon nano tube or carbon nano fiber coating has a thickness in the 100-1000 nm range.

13. The fuel cell stack according to claim 10 wherein the carbon nano tube or carbon nano fiber coating is deposited on the flow field plate by a chemical vapor deposition process that uses acetylene as a carrier gas.

14. The fuel cell stack according to claim 10 wherein a thin Cr or Ni layer is deposited on the flow field plates before the carbon nano tube or carbon nano fiber coating.

15. The fuel cell stack according to claim 10 wherein the carbon nano tube or carbon nano fiber coating is a graphitized carbon nano tube or carbon nano fiber coating.

16. The fuel cell stack according to claim 10 further comprising a plurality of membrane electrode assemblies between the flow field plates, said membrane electrode assemblies including at least one catalyst layer, said catalyst layer including catalyst particles formed in a binder layer, said binder layer being a carbon nano tube or carbon nano fiber binder.

17. A method for making a flow field plate for a fuel cell, said method comprising:
providing a flow field plate; and
depositing a carbon nano tube or carbon nano fiber coating on the flow field plate.

18. The method according to claim 17 wherein providing a flow field plate includes providing a flow field plate made of a material selected from the group consisting of steel, titanium, aluminum and a polymer-carbon composite based material.

19. The method according to claim 17 wherein depositing a carbon nano tube or carbon fiber coating on the flow field plate includes using a chemical vapor deposition process that uses acetylene as a carrier gas.

20. The method according to claim 17 further comprising depositing a thin Cr or Ni layer on the flow field plate before the carbon nano tube or carbon nano fiber coating is deposited.

21. The method according to claim 17 further comprising graphitizing the carbon nano tube or carbon nano fiber coating.

22. The method according to claim 17 further comprising providing a membrane electrode assembly between the flow field plates, said membrane electrode assembly including at least one catalyst layer, said catalyst layer including catalyst particles formed in a binder layer, said binder layer being a carbon nano tube or carbon nano fiber binder.
